(19) United States
(12) Patent Application Publication
(10) Pub. No.: US 2016/0191181 A1
(43) Pub. Date: Jun. 30, 2016

(54) AUDIO BROADCAST RETRANSMISSIONS

(71) Applicant: Qualcomm Technologies International, Ltd., Cambridge (GB)

(72) Inventor: Neil David BAILEY, Cambridge (GB)

(21) Appl. No.: 14/587,697

(22) Filed: Dec. 31, 2014

(51) Int. Cl. H04H 20/86; H04R 27/00

(52) U.S. Cl. CPC H04H 20/86; H04R 27/00; H04R 2420/07

(57) ABSTRACT

A broadcast device configured to broadcast audio streams according to a wireless communications protocol for playout at a plurality of remote devices. Each audio stream comprises audio data arranged in audio frames. The broadcast device is operable in a plurality of retransmission modes. The audio frames are rebroadcast more frequently in one retransmission mode than another. The broadcast device comprises a controller configured to, for each audio stream: (i) select a retransmission mode based on the audio source of the audio data of that audio stream; and (ii) select an audio frame to be rebroadcast according to the selected retransmission mode. The broadcast device also comprises a transmitter configured to rebroadcast the selected audio frame.

### FIELD OF THE INVENTION

This invention relates to retransmissions of broadcast audio data.

### BACKGROUND

The increasing popularity of home entertainment systems is leading to higher expectations from the domestic market regarding the functionality and quality of the associated surround sound speaker systems.

Traditional 5.1 surround sound systems use six speakers wired to a central receiver. The speakers are located in a specific configuration in the room—front left, front centre, front right, rear left, rear right and a subwoofer generally located at the front centre. These multi-speaker systems have been updated with the advent of wireless networks in the home, which enable audio data to be relayed wirelessly from a central hub to the speakers. Typically, the hub has an associated user interface, which enables the user to select the audio data to be relayed for playout at the speakers, for example the user's music stored on the hub device.

Although more convenient for the user, wireless networks do not transport data as reliably as wired networks because they are subject to greater interference. Audio packets which are either not received or received in a corrupted form at the receiver(s) often lead to audible degradation in the audio signal played out from the speakers. Packet loss concealment methods can be employed at the speakers to reduce the audibility of the lost or corrupted audio packets. However, such methods require power-intensive processing at the speakers if they are not to introduce latency into the audio playout. These techniques are at best inferior to the quality obtained by faithful reproduction of the true signal and become increasingly challenged as larger numbers (especially consecutive) of packets are lost.

Thus, there is a need for a technique of increasing the quality of the audio playout in such a system, without requiring power-intensive processing at the speakers.

### SUMMARY OF THE INVENTION

According to a first aspect, there is provided a broadcast device configured to broadcast audio streams according to a wireless communications protocol for playout at a plurality of remote devices, each audio stream derived from an audio source and comprising audio data arranged in audio frames, the broadcast device operable in a plurality of retransmission modes wherein audio frames are rebroadcast more frequently in one retransmission mode than another, the broadcast device comprising: a controller configured to, for each audio stream: (i) select a retransmission mode based on the audio source of the audio data of that audio stream; and (ii) select an audio frame to be rebroadcast according to the selected retransmission mode; and a transmitter configured to rebroadcast the selected audio frame.

The wireless communications protocol may mandate that the remote devices do not send acknowledgement messages to the broadcast device to confirm receipt of the broadcast audio frames.

The broadcast device may be configured to broadcast audio frames using Connectionless Slave Broadcast of the Bluetooth communications protocol.

The controller may be configured to select a retransmission mode having a lower frequency of rebroadcasts compared to other ones of the plurality of retransmission modes when the audio source is a remote audio source and the broadcast device receives the audio data from that remote audio source over a radio link. The radio link may be an A2DP link of the Bluetooth communications protocol.

The controller may be configured to select a retransmission mode having a higher frequency of rebroadcasts compared to other ones of the plurality of retransmission modes when the broadcast device receives the audio data from an audio source over a non-radio link. The non-radio link may be a USB link.

The controller may be configured to control the transmitter to broadcast an audio frame which has not been previously broadcast in preference to rebroadcasting another audio frame.

The wireless communications protocol may mandate that communications take place in time slots, and the controller may be configured to, based on the selected retransmission mode, determine to use a time slot either (i) to rebroadcast an audio frame or (ii) for another function.

The controller may be configured to, based on the selected retransmission mode, set: parameters of the selected audio frame to be rebroadcast; or a transmission power level of the selected audio frame to be rebroadcast.

The wireless communications protocol may mandate that communications take place in time slots, and the transmitter may be configured to broadcast a plurality of audio frames in a single time slot. The controller may be configured to: select for broadcast in the single time slot, available audio frames which have not previously been broadcast; select for rebroadcast in the single time slot, further audio frames according to a selection process in which those audio frames having a higher broadcast priority are selected in preference to those audio frames having a lower broadcast priority; and control the transmitter to transmit the selected available audio frames and the selected further audio frames.

The controller may be configured to select a number of further audio frames so as to fill up the remainder of the single time slot that is not used for the available audio frames.

Each audio frame may comprise audio data and a playout time, the playout time indicative of a time at which the audio data is to be played out at the remote devices, wherein an audio frame is only available for broadcast if it is within a broadcast time window. The broadcast time window may have an upper bound which is the current time plus a first offset, and a lower bound which is the current time plus a second offset. An audio frame is within the broadcast time window when its playout time is between the upper bound and the lower bound.

Suitably, the fewer times an audio frame has been broadcast the higher its broadcast priority. Suitably, the closer the playout time of an audio frame to a lower bound of the broadcast time window, the higher its broadcast priority.

According to a second aspect, there is provided a remote device configured to receive broadcast audio streams according to a wireless communications protocol, each audio stream comprising audio data arranged in audio frames, the remote device being configured to: receive a broadcast audio frame; compare the playout time of the received audio frame with playout times of previously received audio frames; if the playout time of the received audio frame corresponds to the playout time of a previously received audio frame, discard the received audio frame; if the playout time of the received audio frame does not correspond to the playout time of a previously received audio frame: store the audio data and the playout time of the received audio frame; and playout the audio data at the playout time.

According to a third aspect, there is provided a method of broadcasting audio streams from a broadcast device according to a wireless communications protocol for playout at a plurality of remote devices, each audio stream comprising audio data arranged in audio frames, the broadcast device having a plurality of retransmission modes wherein audio frames are rebroadcast more frequently in one retransmission mode than another, the method comprising: for each audio stream, selecting a retransmission mode based on the audio source of the audio data of that audio stream; selecting an audio frame to be rebroadcast according to the selected retransmission mode; and rebroadcasting the selected audio frame.

The method may comprise selecting a retransmission mode having a lower frequency of rebroadcasts compared to other ones of the plurality of retransmission modes when the audio source is a remote audio source and the audio data is received from the remote audio source over a radio link.

### BRIEF DESCRIPTION OF THE DRAWINGS

The present invention will now be described by way of example with reference to the drawings. In the drawings:

FIG. 1 illustrates a wireless speaker system;

FIG. 2 illustrates an exemplary broadcast packet structure;

FIG. 3 illustrates a retransmission method implemented at a broadcast device;

FIG. 4 illustrates a broadcast audio data reception method;

FIG. 5 illustrates an exemplary broadcast device; and

FIG. 6 illustrates an exemplary remote device.

### DETAILED DESCRIPTION

The following description is presented to enable any person skilled in the art to make and use the invention, and is provided in the context of a particular application. Various modifications to the disclosed embodiments will be readily apparent to those skilled in the art. The general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The following describes wireless communication devices for broadcasting data and receiving that broadcasted data. That data is described herein as being transmitted in packets and/or frames and/or messages. This terminology is used for convenience and ease of description. Packets, frames and messages have different formats in different communications protocols. Some communications protocols use different terminology. Thus, it will be understood that the terms “packet” and “frame” and “messages” are used herein to denote any signal, data or message transmitted over the network.

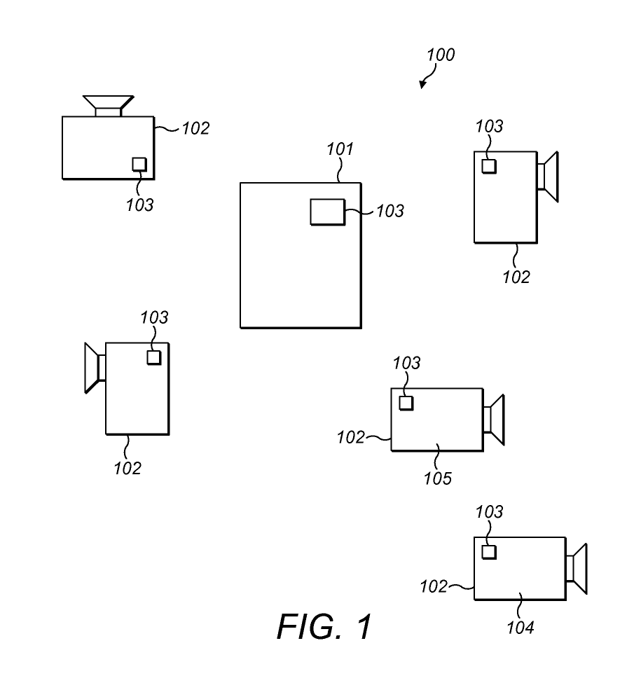

FIG. 1 shows an example of a multi-speaker system 100. The system 100 comprises a hub device 101 and one or more remote devices 102. The hub device 101 and the remote devices 102 each comprise a wireless communication device 103 that operates according to a wireless communications protocol.

The hub device 101 receives audio data from an audio source (not shown). The audio source may be, for example, an external remote device, an internal storage device (e.g. flash memory, hard disk), a removable storage device (e.g. memory card, CD), a networked storage device (e.g. network drive or the cloud), an internet media provider (e.g. a streaming service), radio (e.g. DAB), a microphone, etc. The audio source may be accessible via device 103 or other suitable interfaces (e.g. USB, analogue input, I2S, S/PDIF, Bluetooth, Wi-Fi, etc.). Hub device 101 may be, for example, a smartphone, tablet, PC, laptop, smartwatch, smart glasses, speaker, smart TV, AV receiver, mixer, games console, games controller, media hub, set-top box, Hi-Fi, etc. The hub device 101 broadcasts audio data to the system 100.

Suitably, each remote device 102 (and, optionally, the hub device 101) comprises (or is connected to) an audio output such as a speaker (not shown) for playing audio. The audio output may be connected to the wireless communication device 103 to receive audio for playback.

A remote device 102 may receive the audio data directly from the hub device if it is within communications range of the hub device 101. Alternatively, the remote device may receive the audio data from the hub device indirectly via a relay device. For example, if remote device 104 is outside of the communications range of hub device 101, then remote device 104 may receive an audio broadcast from hub device 101 indirectly via relay device 105. In this situation, relay device 105 may comprise its own speaker (as shown in FIG. 1) or may not comprise a speaker. The relay unit may function solely to relay messages. The relay unit may have a different primary function to playing media.

The example of FIG. 1 shows five speakers 102. However, many more speakers (e.g. tens, hundreds, even thousands of speakers) can be added to the system 100, as explained below. The speakers 102 may be, for example, stand-alone speakers or integrated into other devices such as smartphones, TVs, docking stations, Hi-Fis, etc.

The following description relates to audio communications between a hub device and a set of remote devices, which operate according to a protocol in which audio is streamed from the hub device, directly or indirectly, to the remote devices via a uni-directional broadcast. In an exemplary case, this protocol is the Connectionless Slave Broadcast of the Bluetooth protocol. The examples that follow describe operations in accordance with the Connectionless Slave Broadcast of the Bluetooth protocol. However, the methods described below apply equally to any protocol which transmits audio data from the hub device to the remote devices via a uni-directional link.

The Connectionless Slave Broadcast (CSB) mode is a feature of Bluetooth which enables a Bluetooth piconet master to broadcast data to any number of connected slave devices. This is different to normal Bluetooth operations, in which a piconet is limited to eight devices: a master and seven slaves. In the CSB mode, the master device reserves a specific logical transport for transmitting broadcast data. That broadcast data is transmitted in accordance with a timing and frequency schedule. The master transmits a synchronisation train comprising this timing and frequency schedule on a Synchronisation Scan Channel. In order to receive the broadcasts, a slave device first implements a synchronisation procedure. In this synchronisation procedure, the slave listens to the Synchronisation Scan Channel in order to receive the synchronisation train from the master. This enables it to determine the Bluetooth clock of the master and the timing and frequency schedule of the broadcast packets. The slave synchronises its Bluetooth clock to that of the master for the purposes of receiving the CSB. The slave device may then stop listening for synchronisation train packets. The slave opens its receive window according to the timing and frequency schedule determined from the synchronisation procedure in order to receive the CSB broadcasts from the master device.

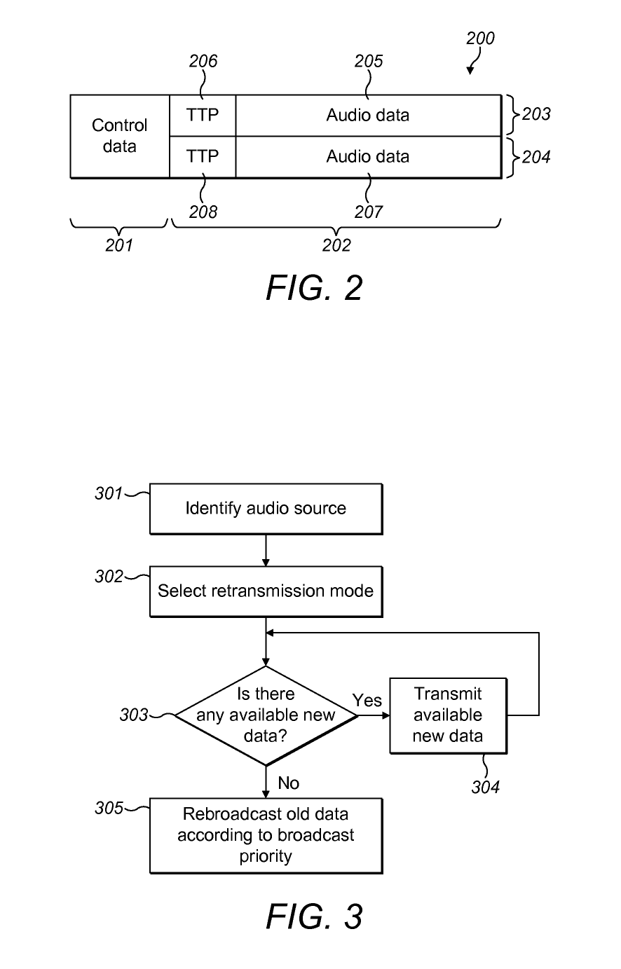

In the following example, the hub device 101 of FIG. 1 broadcasts audio data using CSB. FIG. 2 illustrates an example structure of a broadcast packet 200. The broadcast packet 200 comprises a header 201 for control data and a payload 202 for audio related data. Control data may comprises commands, such as play, pause, stop and/or playback rates, equilisation data etc. Payload 202 comprises one or more audio frames 203, 204. Each audio frame comprises audio data 205, 207 and playout time data 206, 208 referred to in FIG. 2 as TTP (time-to-play) data. The hub device 101 encapsulates one or more audio frames and control data for those frames in the broadcast packet 200. The hub device 101 transmits the broadcast packets in accordance with the timing and frequency schedule of its CSB. The audio packets may be transmitted using DH3 packets as defined in the Bluetooth specification. Suitably, the hub device dedicates specific time slots to the broadcast of audio data. It is configured to transmit as many audio frames as it can within each time slot before reaching the guard interval of the next time slot.

The remote devices 102 of FIG. 1 receive the broadcast packets 200 transmitted by hub device 101 either directly or indirectly via a relay device. The remote devices 102 are configured to store the received audio data of an audio frame and to play it out at the time indicated by the time-to-play field of the audio frame.

As mentioned above, the hub device 101 receives audio data from an audio source. For example, the audio source may be a local store integrated within the hub device. Alternatively, the audio source may be external to the hub device. An external audio source may be connected to the hub device by a wire, for example a USB source. Alternatively, the external audio source may be connected to the hub device by a radio link, for example by an A2DP (Advanced Audio Distribution Profile) connection. The audio data may be received over an A2DP connection at ˜280 kbps. An ACL (asynchronous connection logical transport) link may be used. Alternatively, an eSCO (extended synchronous connection-oriented) link may be used.

On receiving audio data from an audio source, the hub device 101 calculates the playout time for each audio frame. The playout time of an audio frame is calculated as an offset from the current time, as measured by the hub device's internal clock. The offset allows time for the audio data to be re-encoded and broadcast to the remote devices and processed at the remote devices ready for playout.

The hub device 101 and the remote devices 102 may be capable of encoding and decoding audio according to one or more codecs. Preferably, hub device 101 and remote devices 102 are capable of operating with the same preferred codec. An exemplary codec is Constrained Energy Lapped Transform (CELT). Other example codecs include Subband Coding (SBC), aptX and MP3. Any suitable codec may be supported. The hub device 101 may convert audio from one format to another format that is suitable for transmitting to the remote devices 102. For example, the bandwidth for transmission may be limited and thus a suitable codec is selected that encodes and compresses audio so that it is able to be transmitted within the available bandwidth and at a required level of quality. For example, the hub device 101 may receive Pulse Code Modulation (PCM) audio (which has a high bitrate) as its source audio and convert that PCM audio to CELT (which has a lower bitrate) and transmit the CELT encoded data to remote devices 102. The audio may be encoded into a series of frames, which may be of fixed or variable size. The audio data may be compressed.

After the audio data has been encoded and encapsulated into broadcast packets, it is broadcast from the hub device. For example, it may be broadcast at a rate of ˜100 kbps. Suitably, the hub device also retains a local copy of the audio data, and plays it out locally at the specified playout time. In this example, both the hub device and the remote devices play out the audio together at the playout time.

CSB is a uni-directional link. In other words, the remote devices 102 are not able to respond to the hub device 101 using the CSB link. Thus, the remote devices 102 are not able to send, via the CSB link, acknowledgment messages to the hub device 101 to confirm receipt of the broadcast packets. Similarly, the remote devices 102 are not able to send, via the CSB link, retransmission requests if they receive a corrupted broadcast packet. If a remote device receives a corrupted packet or does not receive a packet, it may perform packet loss concealment to limit the audible degradation to the signal. Alternatively, the remote device may repeat the last audio frame until a later correctly received audio frame is available to playout. As a further alternative, the remote device may playout silence for the timespan of the missing packet. Since the hub device 101 does not receive acknowledgement messages from the remote devices 102, it does not know whether the remote devices 102 have correctly received the broadcast packets. The hub device therefore implements a retransmission mechanism, in which it retransmits audio frames in order to increase the likelihood of the remote devices correctly receiving each audio frame.

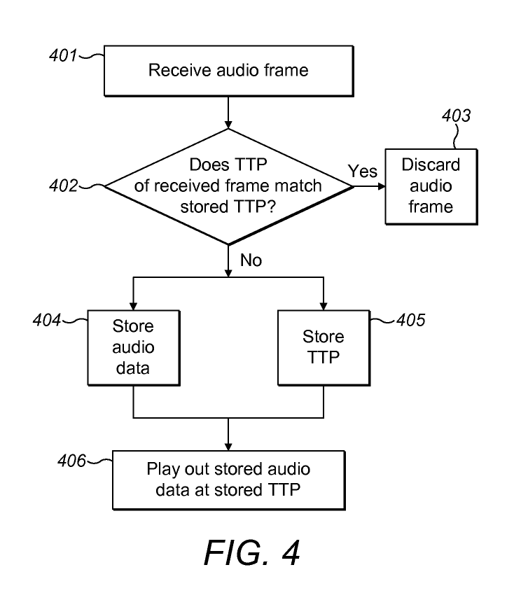

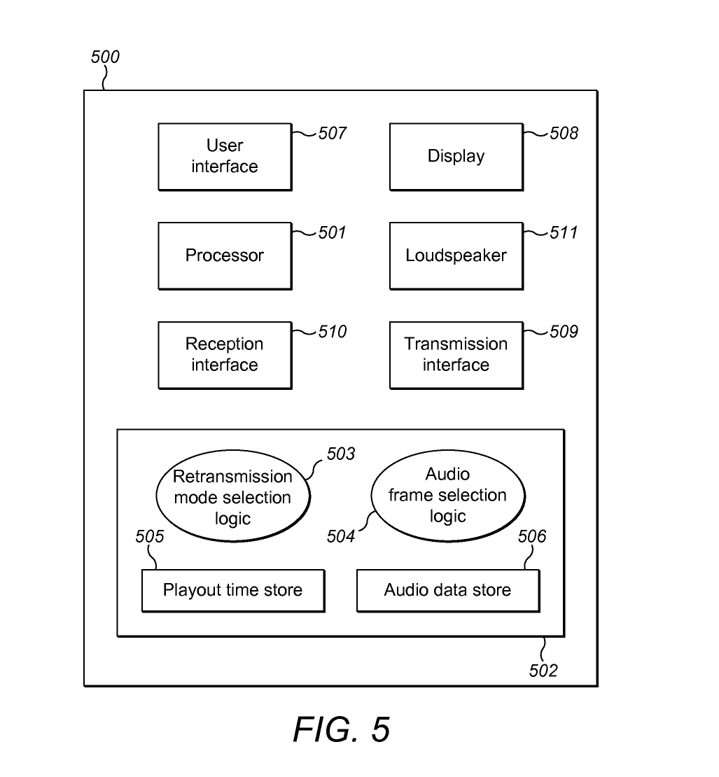

The methods described with respect to FIGS. 3 and 4 relate to an adaptive retransmission mechanism implemented by the hub device in dependence on the audio source of the audio data. The methods described with respect to FIGS. 3 and 4 are for illustrative purposes only. Not all the method steps are necessarily required, and the steps do not necessarily need to occur in the order illustrated.

The audio broadcast operation of the hub device will now be described with respect to FIG. 3. At step 301, when the hub device is to broadcast an audio stream, it identifies the audio source of the audio stream. At step 302, the hub device then selects a retransmission mode in dependence on the audio source.

The hub device is capable of operating in a plurality of retransmission modes. The hub device's approach to retransmissions is different in the different retransmission modes. For example, the hub device may be configured to attempt fewer retransmissions in one retransmission mode compared to another retransmission mode. For example, when the hub device receives audio data from a remote audio source over a radio link which uses the same protocol (or a protocol/standard with an overlapping frequency range) as the protocol which the hub device uses to broadcast the audio data to the remote devices, the hub device selects a retransmission mode which rebroadcasts audio frames less frequently than other retransmission modes. For example, when the hub device receives audio data over an A2DP Bluetooth link and it is to broadcast that audio data over a CSB Bluetooth link, the hub device selects a retransmission mode which rebroadcasts audio frames less frequently than other retransmission modes. In this case, the hub device has a limited number of Bluetooth time slots available to it. Since some of these Bluetooth time slots are utilised for receiving the audio data from the A2DP source, the number of Bluetooth time slots available to the hub device is lower than if the audio data was not received remotely over a radio link, thus the hub device chooses to implement a retransmission mode which rebroadcasts the audio frames less frequently. On the other hand, if the hub device receives audio data over a non-radio link (such as USB), then the number of Bluetooth slots available to it for broadcasting audio data is higher than if the audio data was received over a radio link, thus the hub device chooses to implement a retransmission mode which rebroadcasts the audio frames more frequently.

At step 303 of FIG. 3, the hub device determines whether there is any available new data. The hub device is configured to broadcast audio data that has not previously been broadcast in preference to rebroadcasting audio data that has previously been broadcast. An audio frame is only available if it lies within a broadcast time window. An audio frame lies within the broadcast time window if its playout time lies between the upper and lower bounds of the broadcast time window.

The lower bound of the broadcast time window is such that if the audio frame was chosen for broadcast, there would be sufficient time for it to be encoded by the hub device, transmitted by the hub device, received by the remote devices, decoded by the remote devices and played out at the playout time. If, by the time the remote devices were able to play out the audio data in an audio frame, the playout time had already passed, then the audio frame would not lie within the broadcast time window. The offset from the current time of the lower bound of the window depends on the distance to the remote devices and how quickly the remote devices are able to process the received audio frames ready for play out. This may be, for example, ˜55 ms. The remote devices have limited buffer space for storing the audio data prior to playing that audio data out.

The upper bound of the broadcast time window is such that if all the audio frames were broadcast ahead of their playout time by an amount determined by the upper bound, the remote devices would have enough buffer space to be able to store all the audio frames prior to playing their audio data out. The offset from the current time of the upper bound of the window depends on the distance to the remote devices, how quickly the remote devices are able to process the received audio frames ready for play out, and the buffer capabilities of the remote devices.

The upper and lower bounds of the window may be predetermined Alternatively, the upper and lower bounds of the window may be configurable in dependence on the capabilities and locations of the hub device and remote devices. The upper and lower bounds of the window may be dynamically configurable.

If, at step 303, the hub device determines that there is available new audio data, then this new audio data is selected for broadcast, and is broadcast by a transmitter of the hub device at step 304. If the hub device determines that there is no available new audio data, then the method proceeds to step 305.

At step 305, the hub device rebroadcasts old audio data. In other words, audio frames which have previously been broadcast are selected for rebroadcast, and are rebroadcast by the transmitter. The hub device selects the audio frames to be rebroadcast in accordance with the selected transmission mode. Suitably, an audio frame is only selected for rebroadcast if it lies within the broadcast time window. In one example, the audio frames are assigned broadcast priorities, and a selection process is implemented in which those audio frames having a higher broadcast priority are selected for rebroadcast in preference to those audio frames having a lower broadcast priority. The more times an audio frame has been broadcast, the lower its broadcast priority. The fewer times an audio frame has been broadcast, the higher its broadcast priority. Optionally, the closer the playout time of an audio frame to the lower bound of the broadcast time window, the higher its broadcast priority.

Thus, for a given time slot to be used for broadcasting audio data, the hub device prioritises broadcasting audio frames that have not previously been broadcast. The hub device then fills up the remainder of the time slot by rebroadcasting audio frames that have previously been broadcast.

The hub device may select one or more parameters of the rebroadcasted audio frames in dependence on the retransmission mode.

For example, the hub device may select the transmission power level of the audio frame to be retransmitted based on the retransmission mode. The transmission power level may be varied depending on how many times that audio frame has been broadcast. For example, the transmission power level of the audio frame may be initially lower, and then increased every time that audio frame is rebroadcast. Transmitting the audio frame at a lower power substantially prevents remote devices in close proximity to the hub device from overloading their RF front ends, which results in corrupted data being decoded. Having correctly received the audio data in a low power packet, the remote devices close by the hub device discard higher power retransmissions because they are redundant. Transmitting the audio frame at a higher power increases the range of that audio frame. In other words, the higher the power of the transmission, the further away the remote devices can be located from the hub device and still correctly directly receive the broadcast packet.

As another example, the hub device may select the codec to be used based on the retransmission mode. This may affect the frequency of retransmissions in that retransmission mode. For example, if a low bandwidth codec is selected, then the hub device may have more time slots available, and hence be able to increase the average number of times each audio frame is rebroadcast.

As another example, the hub device may select the modulation scheme to be used based on the retransmission mode. The modulation scheme may be varied depending on how many times that audio frame has been broadcast. For example, for an initial broadcast of an audio frame a high bit rate modulation scheme may be used, such as 16 QAM. And then, for rebroadcasts increasingly more robust modulation schemes that can tolerate more interference may be used, for example QPSK. The bit rate of these schemes is lower, but this approach increases the likelihood of the remote devices receiving the broadcast.

As a further example, the hub device may implement forward error correction (FEC) in the broadcast packets, and it may select the FEC code rate to be used based on the retransmission mode. A more redundant FEC code may be used each time an audio frame is rebroadcast to increase the likelihood of a remote device correctly decoding the audio data in poor signal conditions.

The hub device may be utilising the wireless communications protocol that it is using to broadcast the audio frames for other purposes. For example, in the case of Bluetooth, the hub device may be utilising the available Bluetooth time slots for maintaining other Bluetooth links in addition to broadcasting audio. For example, if the hub device is a tablet, it may be performing other functions using Bluetooth, such as transmitting image files to another device, controlling the functionality of a keyboard, controlling local appliances such as lights or heating. The hub may determine which time slots to allocate to which Bluetooth links in part based on the retransmission mode. The hub device allocates sufficient time slots to the broadcast of the audio frames that all the audio frames are broadcast at least once. The hub device may arbitrate between using some or all of the remainder of the time slots to (i) rebroadcast audio frames that have already been broadcast at least once, (ii) transmit or receive on another link for another function the hub device is performing, or (iii) use the time slot to discover new devices to connect to.

The number of times an audio frame is rebroadcast is limited by the retransmission mode, by the time slot usage of the hub device and by the playout time of the audio frame (since the audio frame will not be rebroadcast after it is too close to its playout time for the remote devices to be able to receive the audio frame and play out its audio data at the playout time).

On average, the number of times an audio frame is broadcast when the audio source of its audio data is an A2DP link to the hub device may be 3 or 4 broadcasts. For example, the audio broadcast packets may be transmitted at an interval of ˜10 ms. On average, the number of times an audio frame is broadcast when the audio source of its audio data is a USB link to the hub device may be 5 or 6 broadcasts. For example, the audio broadcast packets may be transmitted at an interval of ˜5 ms.

In the case that the broadcast from the hub device is relayed via one or more relay devices to the remote device, each of those relay devices may affect the retransmissions. For example, a relay device may be battery powered, and thus reduce the number of time slots that are used for relaying audio broadcasts in order to conserve power. In this case, the relay device may store the TTPs of the audio frames that it relays on to other devices, and limit the number of times it relays an audio frame having the same TTP in order to reduce the data being relayed, and hence reduce the number of time slots needed for relaying the data.

The reception of an audio broadcast at a remote device will now be described with respect to FIG. 4. At step 401, the remote device receives a broadcast audio frame. Next, at step 402, the remote device extracts the playout time from the audio frame, shown in FIG. 4 as TTP (time-to-play). The remote device compares the TTP to its store of TTP values from previously received audio frames of this broadcast audio stream. If the TTP of the received audio frame matches a stored TTP, then, at step 403, the remote device discards the received audio frame. This is because the remote device has already received a broadcast of this audio frame and stored the encapsulated audio data for playout at the TTP. The received audio frame is thus a redundant rebroadcast from the point of view of the remote device. If the TTP of the received audio frame does not match a stored TTP, then, at step 404, the remote device stores the audio data encapsulated in the audio frame in an audio data store. Also, at step 405, the remote device stores the TTP encapsulated in the audio frame in a TTP store. This is because the remote device has not previously correctly received a broadcast of this audio frame, thus it extracts the audio data and TTP in order to play out the audio data at the TTP. At step 406, the remote device then plays out the stored audio data from audio data store at the associated stored TTP.

Reference is now made to FIG. 5. FIG. 5 illustrates a computing-based device 500 in which the described hub device can be implemented. The computing-based device may be an electronic device. The computing-based device illustrates functionality used for selecting a retransmission mode, selecting an audio frame to broadcast, and for transmitting audio data.

Computing-based device 500 comprises a processor 501 for processing computer executable instructions configured to control the operation of the device in order to perform the broadcasting method. The computer executable instructions can be provided using any non-transient computer-readable media such as memory 502. Further software that can be provided at the computer-based device 500 includes retransmission mode selection logic 503 which implements step 302 of FIG. 3, and audio frame selection logic 504 which implements steps 303, 304 and 305 of FIG. 3. Alternatively, the controller for selecting the retransmission and for selecting the audio frame to broadcast are implemented partially or wholly in hardware. Store 505 stores the playout time, TTP, of each audio frame. Store 506 stores the audio data to be played out. Computing-based device 500 also comprises a user interface 507. The user interface 507 may be, for example, a touch screen, one or more buttons, a microphone for receiving voice commands, a camera for receiving user gestures, a peripheral device such as a mouse, etc. The user interface 507 allows a user to control the audio that is to be played back by the remote devices. For example, a user may select the music to be played back, start/stop the music, adjust a volume level for the music, etc. via the user interface 507. The computing-based device 500 may further comprise a display 508. This may be incorporated within the user interface 507. The computing-based device 500 also comprises a transmission interface 509 for transmitting the broadcast audio packets. The computing-based device 500 may also comprise a reception interface 510 for receiving audio data from an audio source. The transmitter and receiver collectively include an antenna, radio frequency (RF) front end and a baseband processor. In order to transmit signals the processor 501 can drive the RF front end, which in turn causes the antenna to emit suitable RF signals. Signals received at the antenna can be pre-processed (e.g. by analogue filtering and amplification) by the RF front end, which presents corresponding signals to the processor 501 for decoding. The computing-based device 500 may also comprise a loudspeaker 511 for playing the audio out locally at the playout time.

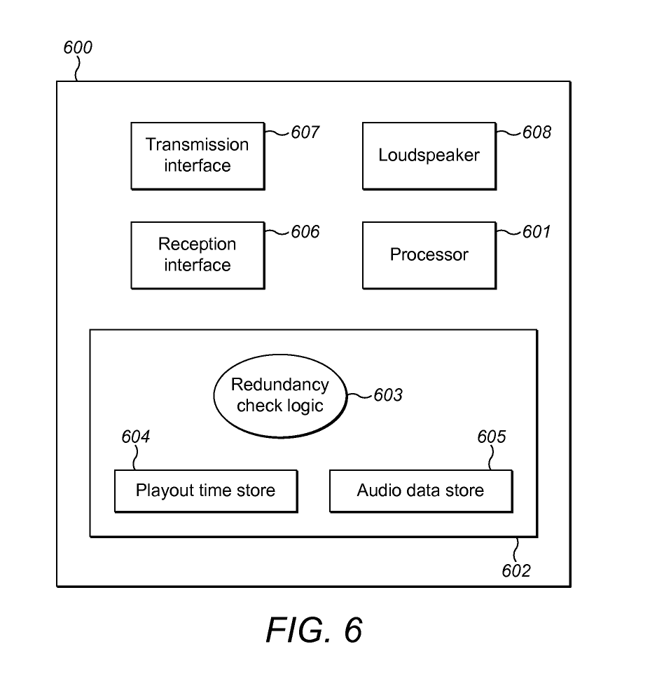

Reference is now made to FIG. 6. FIG. 6 illustrates a computing-based device 600 in which the described remote device can be implemented. The computing-based device may be an electronic device. The computing-based device illustrates functionality used for assessing whether a received broadcast audio frame has been previously received, for storing the audio data and playout time of received frames, and for playing out the audio data of the received frames.

Computing-based device 600 comprises a processor 601 for processing computer executable instructions configured to control the operation of the device in order to perform the reception method. The computer executable instructions can be provided using any non-transient computer-readable media such as memory 602. Further software that can be provided at the computer-based device 600 includes redundancy check logic 603 which implements step 402 of FIG. 4. Alternatively, the redundancy check may be implemented partially or wholly in hardware. Store 604 stores the playout times, TTP, of audio frames. Store 605 stores the audio data of the audio frames. Computing-based device 600 further comprises a reception interface 606 for receiving the broadcast audio from the hub device. The computing-based device 600 may additionally include transmission interface 607. The transmitter and receiver collectively include an antenna, radio frequency (RF) front end and a baseband processor. In order to transmit signals the processor 601 can drive the RF front end, which in turn causes the antenna to emit suitable RF signals. Signals received at the antenna can be pre-processed (e.g. by analogue filtering and amplification) by the RF front end, which presents corresponding signals to the processor 601 for decoding. The computing-based device 600 also comprises a loudspeaker 608 for playing the audio out locally at the playout time.

The applicant draws attention to the fact that the present invention may include any feature or combination of features disclosed herein either implicitly or explicitly or any generalisation thereof, without limitation to the scope of any of the present claims. In view of the foregoing description it will be evident to a person skilled in the art that various modifications may be made within the scope of the invention.

1. A broadcast device configured to broadcast audio streams according to a wireless communications protocol for playout at a plurality of remote devices, each audio stream derived from an audio source and comprising audio data arranged in audio frames, the broadcast device operable in a plurality of retransmission modes wherein audio frames are rebroadcast more frequently in one retransmission mode than another, the broadcast device comprising:
a controller configured to, for each audio stream:
(i) select a retransmission mode based on the audio source of the audio data of that audio stream; and
(ii) select an audio frame to be rebroadcast according to the selected retransmission mode; and
a transmitter configured to rebroadcast the selected audio frame.

2. A broadcast device as claimed in claim 1, wherein the wireless communications protocol mandates that the remote devices do not send acknowledgement messages to the broadcast device to confirm receipt of the broadcast audio frames.

3. A broadcast device as claimed in claim 1, configured to broadcast audio frames using Connectionless Slave Broadcast of the Bluetooth communications protocol.

4. A broadcast device as claimed in claim 1, wherein the controller is configured to select a retransmission mode having a lower frequency of rebroadcasts compared to other ones of the plurality of retransmission modes when the audio source is a remote audio source and the broadcast device receives the audio data from that remote audio source over a radio link.

5. A broadcast device as claimed in claim 4, wherein the radio link is an A2DP link of the Bluetooth communications protocol.

6. A broadcast device as claimed in claim 1, wherein the controller is configured to select a retransmission mode having a higher frequency of rebroadcasts compared to other ones of the plurality of retransmission modes when the broadcast device receives the audio data from an audio source over a non-radio link.

7. A broadcast device as claimed in claim 6, wherein the non-radio link is a USB link.

8. A broadcast device as claimed in claim 1, wherein the controller is configured to control the transmitter to broadcast an audio frame which has not been previously broadcast in preference to rebroadcasting another audio frame.

9. A broadcast device as claimed in claim 1, wherein the wireless communications protocol mandates that communications take place in time slots, and the controller is configured to, based on the selected retransmission mode, determine to use a time slot either (i) to rebroadcast an audio frame or (ii) for another function.

10. A broadcast device as claimed in claim 1, wherein the controller is configured to, based on the selected retransmission mode, set parameters of the selected audio frame to be rebroadcast.

11. A broadcast device as claimed in claim 10, wherein the controller is configured to, based on the selected retransmission mode, set a transmission power level of the selected audio frame to be rebroadcast.

12. A broadcast device as claimed in claim 1, wherein the wireless communications protocol mandates that communications take place in time slots, and wherein the transmitter is configured to broadcast a plurality of audio frames in a single time slot, the controller being configured to:
select for broadcast in the single time slot, available audio frames which have not previously been broadcast;
select for rebroadcast in the single time slot, further audio frames according to a selection process in which those audio frames having a higher broadcast priority are selected in preference to those audio frames having a lower broadcast priority; and
control the transmitter to transmit the selected available audio frames and the selected further audio frames.

13. A broadcast device as claimed in claim 12, wherein the controller is configured to select a number of further audio frames so as to fill up the remainder of the single time slot that is not used for the available audio frames.

14. A broadcast device as claimed in claim 12, wherein each audio frame comprises audio data and a playout time, the playout time indicative of a time at which the audio data is to be played out at the remote devices, wherein an audio frame is only available for broadcast if it is within a broadcast time window.

15. A broadcast device as claimed in claim 14, wherein the broadcast time window has an upper bound which is the current time plus a first offset, and a lower bound which is the current time plus a second offset, and wherein an audio frame is within the broadcast time window when its playout time is between the upper bound and the lower bound.

16. A broadcast device as claimed in claim 12, wherein the fewer times an audio frame has been broadcast the higher its broadcast priority.

17. A broadcast device as claimed in claim 14, wherein the closer the playout time of an audio frame to a lower bound of the broadcast time window, the higher its broadcast priority.

18. A remote device configured to receive broadcast audio streams according to a wireless communications protocol, each audio stream comprising audio data arranged in audio frames, the remote device being configured to:
receive a broadcast audio frame;
compare the playout time of the received audio frame with playout times of previously received audio frames;
if the playout time of the received audio frame corresponds to the playout time of a previously received audio frame, discard the received audio frame;
if the playout time of the received audio frame does not correspond to the playout time of a previously received audio frame:
store the audio data and the playout time of the received audio frame; and
playout the audio data at the playout time.

19. A method of broadcasting audio streams from a broadcast device according to a wireless communications protocol for playout at a plurality of remote devices, each audio stream comprising audio data arranged in audio frames, the broadcast device having a plurality of retransmission modes wherein audio frames are rebroadcast more frequently in one retransmission mode than another, the method comprising:
for each audio stream, selecting a retransmission mode based on the audio source of the audio data of that audio stream;
selecting an audio frame to be rebroadcast according to the selected retransmission mode; and
rebroadcasting the selected audio frame.

20. A method as claimed in claim 19, comprising selecting a retransmission mode having a lower frequency of rebroadcasts compared to other ones of the plurality of retransmission modes when the audio source is a remote audio source and the audio data is received from the remote audio source over a radio link.
